(19) United States
(12) Patent Application Publication
(10) Pub. No.: US 2016/0057187 A1
(43) Pub. Date: Feb. 25, 2016

(54) Multimedia queuing and collaboration method

(71) Applicant: James A. Hess, Mountain Top, PA (US)

(72) Inventor: James A. Hess, Mountain Top, PA (US)

(21) Appl. No.: 14/463,103

(22) Filed: Aug. 19, 2014

(51) Int. Cl. H04L 29/06

(52) U.S. Cl. CPC H04L 65/4084; H04L 69/26

(57) ABSTRACT

The invention relates to the use of smart media devices to communicate wirelessly with a central smart media device in a collaborative environment allowing the ability for individuals to stream media content to the central device in a social atmosphere. One of the major challenges with the exponential expansion of media content and smart devices is the ability to share in a collaborative environment media content so as not to violate copy write and trademark protections.

### SUMMARY OF THE INVENTION

In order to facilitate the sharing of media content in a collaborative environment without infringing copy write and trademark rights a network based media rendering environment is established, whereby, authorized users subscribe to a service granting them access to a steam content to a central server within a given venue.

As this is a streamed environment copy write and trade mark integrity is maintained while an individual's content remains on the user's device. This is accomplished through the modification of a standard windows player to allow for the queuing and filtering of content and the rendering of the content on a central device within a social environment. In a practical process this environment will allow for the streaming of advertisement and marketing content by the rendering server provider within their localized environment.

The end user utilizes commonly available device players that sense the localized rendering server (s) and selects the server destination and content. This content is filtered and entered into the queue. The rendering system server, after an authentication process sends a verification packet to a separate off site process server. Upon verification the content is entered into the rendering queue for social sharing.

### BRIEF DESCRIPTION OF DRAWINGS (INCLUDED SEPARATELY)

The following invention and its future applications can be better understood when read with the accompanying drawings, where referenced characters refer to like parts, in which:

FIG. 1 is a schematic block diagram of the rendering and collaboration process.

### DETAILED DESCRIPTION OF THE PREFERRED EMBODIMENT

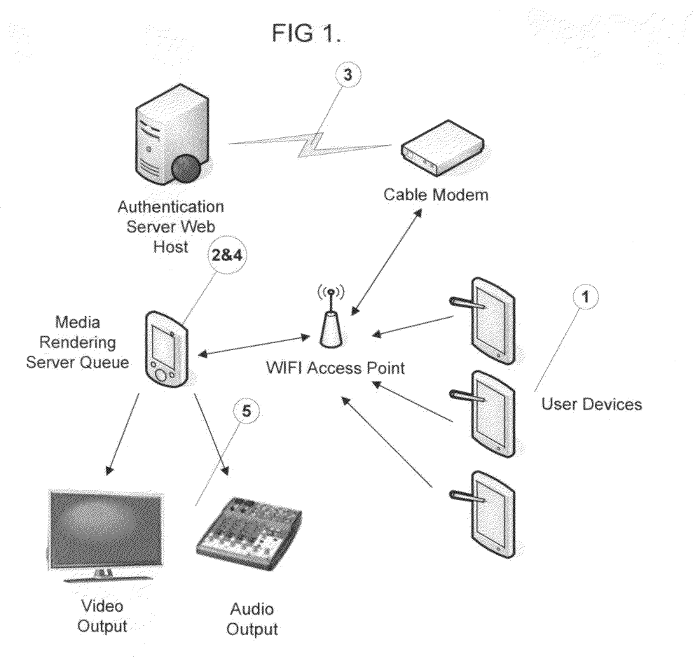

In reference to FIG. 1, the call out detail is as follows:
1) User devices utilize common media play back applications and select the rendering server as the target for their local media content via a local Wi-Fi.
2) The rendering server receives the user request, device information and user account information.
3) The rendering server accesses the authentication server web host and verifies the user account information.
4) Upon verification of the user data the rendering server queues the media content to be streamed from the user device based on applied filters defined on the rendering filter for content and context.
5) The queued media is rendered and played back on the appropriate device.

One of the major challenges with the exponential expansion of media content and smart devices is the ability to share media content so as not to violate copy write and trademark protections.

Previous patents for media sharing in a steamed environment have focused on peer to peer or server-peer streaming scenarios, examples being U.S. Pat. Nos.

U.S. Pat. No. 8,694,024

U.S. Pat. No. 8,706,159

U.S. Pat. No. 8,516,529

The commonalities of these designs are their references to nodal streaming from a server to a device or a device to another device. In no sited patent is there a defined a scenerio where multiple personal devices are streaming to a central rendering server with the capability of Queueing content from those multiple sources in a central location.

What is claimed is:

1. Where current media streaming applications and environments are restricted to peer to peer or server to peer configurations, the collaboration environment described focusses on a device to rendering server configuration for streamed content. In this scenario users are not limited to content defined by the service provider and without legal infringement can share their personal content with a social environment with rules defined on the rendering server.
